(19) United States
(12) Patent Application Publication
(10) Pub. No.: US 2010/0175080 A1
(43) Pub. Date: Jul. 8, 2010

(54) METHOD AND SYSTEM FOR FACILITATING ADVERTISING AND T-COMMERCE TRANSACTIONS IN CONNECTION WITH CONTENT STORED ON A STORAGE MEDIUM

(75) Inventors: Henry C. Yuen, Pasadena, CA (US); Elsie M. Leung, South Pasadena, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: Index Systems, Inc, Los Angeles, CA (US)

(21) Appl. No.: 12/556,484

(22) Filed: Sep. 9, 2009

Related U.S. Application Data
(63) Continuation of application No. 10/427,698, filed on May 1, 2003, now abandoned.
(60) Provisional application No. 60/377,143, filed on May 1, 2002.

(51) Int. Cl. H04N 7/10

(52) U.S. Cl. 725/32

(57) ABSTRACT

In one embodiment, the present invention is an improved interactive television system and method for t-commerce. In this embodiment, the present invention relates to a method for facilitating transactions by a user through a television system including a playback device. The method includes providing a first storage medium with pre-recorded content stored on the recording medium; storing an interactive advertisement on the first storage medium; generating a trigger for the interactive advertisement; displaying the interactive advertisement on the television system in response to the trigger when the first storage medium is played by the playback device; prompting the user to respond to the interactive advertisement; generating a transaction request from the user response; and transmitting the transaction request through the television system.

This embodiment of the invention further includes storing a user identification within the television system and generating a transaction request from the user response and the user identification. The user identification may be stored in a second storage medium distinct from the first storage medium. Additionally, an electronic wallet including personal information of the user may be stored.

### CROSS-REFERENCE TO RELATED APPLICATION(S)

This patent application claims the benefit of the filing date of U.S. Provisional Patent Application Ser. No. 60/377,143, filed May 1, 2002 and entitled “METHOD AND SYSTEM FOR FACILITATING ADVERTISING AND T-COMMERCE TRANSACTIONS IN CONNECTION WITH CONTENT STORED ON A STORAGE MEDIUM,” the entire content of which is hereby expressly incorporated by reference.

### SUMMARY OF THE INVENTION

The present invention generally relates to advertising and t-commerce transactions, and more particularly to advertising and t-commerce transactions occurring in connection with recorded content stored on a storage medium.

### BACKGROUND OF THE INVENTION

Television commerce or t-commerce is conventionally viewed as a subset of interactive television and is generally defined as electronic commerce where the electronic commerce transactions occur over the medium of television, or similar devices. Although t-commerce is still in its early stages, it is projected to play a significant role in the growth and acceptance of interactive television.

T-commerce transactions may be conducted in a full screen television mode, or through an interactive program guide (“IPG”). Generally speaking, an IPG is an on-screen listing of television program information with interactive functions that enable users (viewers) to navigate through, sort, select and schedule television programming for viewing and recording. An IPG may include different regions for displaying advertisements and other messages.

Alternatively, the t-commerce opportunity may be presented to a user outside of the IPG. For example, advertising or t-commerce opportunities may be presented to a user in connection with a currently broadcast television program or advertisement.

The advertising and t-commerce examples described above are integrated with real-time or currently broadcast, rather than, recorded television programs, either through the IPG or outside of the IPG. However, users may spend a significant portion of their television viewing hours watching recorded programs, such as Digital Video Discs (DVDs). As a result, there is a need for presenting similar advertising and t-commerce opportunities to users of recorded or pre-recorded content in a manner that allows service providers and others to leverage the existing investments in infrastructure that have been made to facilitate such transactions.

### SUMMARY OF THE INVENTION

The present invention, provides a method and system for providing advertising and t-commerce opportunities in connection with recorded or pre-recorded content stored on a storage medium. More specifically, the present invention leverages existing investments in infrastructure initially made to support advertising and t-commerce in connection with real-time or currently broadcast television programs to extend similar opportunities to users of recorded or pre-recorded content. To provide such opportunities, an interactive advertisement is stored with pre-recorded content on a storage medium (e.g. DVD). The interactive advertisement is triggered and displayed when a playback device plays the content stored on the storage medium. Depending on the nature of the interactive advertisement, a user may be prompted to respond to the advertisement. Using the user's response, along with possibly some personal information regarding the user that is already stored within the system, a transactional request is generated and submitted through the television system.

In one aspect, the present invention relates to a method and system for facilitating transactions by a user through a television system including a playback device. The method and system includes storing program content including an interactive advertisement on a first storage medium; playing the stored program content including the interactive advertisement by the playback device; generating a trigger in response to the playing the stored program content; displaying the interactive advertisement on the television system in response to the trigger; responding to the displayed advertisement by the user; generating a transaction request from the user response to the displayed advertisement; and transmitting the transaction request to a remote site.

This aspect of the invention may further include prompting the user to respond to the interactive advertisement and/or storing a user identification within the television system and generating a transaction request from the user response and the user identification. The user identification may be stored in a second storage medium distinct from the first storage medium. Additionally, an electronic wallet including personal information of the user may be stored.

The first storage medium may include a non-volatile storage medium such as a: floppy disk, hard disk, optical disk; flash memory, DVD, CD, or videotape. The user identification may be stored in a memory of (or operatively connected to) a consumer electronics device such as a: set top box (STB), television, video cassette recorder (VCR), CD-R(W); DVD-R(W), or personal video recorder (PVR), personal computer (PC). The invention may further include a transaction template stored in the television system for generating a transaction request from the transaction template and user response. Additionally, a return path may be provided within the television system for the transactional request. The trigger may be stored on the first storage medium. The trigger may also be transmitted through the television system.

In another aspect, the present invention relates to a television system for facilitating transactions by a user. The television system includes a first storage medium for storing program content and an interactive advertisement; a trigger for the interactive advertisement; a playback device coupled to the first storage medium for playing the stored program content and the interactive advertisement; a display screen coupled to the playback device for displaying the interactive advertisement on the television system in response to the trigger when the stored program content and the interactive advertisement are played by the playback device; an input device for responding to the displayed advertisement by the user; a microprocessor for generating a transaction request from the user response to the displayed advertisement; and a communication path coupled to the microprocessor for transmitting the transaction request to a remote site.

### BRIEF DESCRIPTION OF THE DRAWINGS

The objects, advantages and features of this invention will become more apparent from a consideration of the following detailed description and the drawings in which:

FIGS. 1A-1B depict an exemplary IPG and an advertisement displayed within the exemplary IPG, in accordance with one embodiment of the present invention;

FIG. 1C depicts a full screen advertisement for a product, in accordance with one embodiment of the present invention;

FIGS. 1D-1G are exemplary screens depicting information and instructions on how to order a product directly through the television, in accordance with one embodiment of the present invention;

FIGS. 2A-2B are exemplary block diagrams of a television system, in accordance with one embodiment of the present invention;

FIG. 3 is an exemplary remote controller, in accordance with one embodiment of the present invention;

FIGS. 4A-4C are exemplary screens depicting a pre-recorded music video stored on a DVD, in accordance with one embodiment of the present invention;

FIG. 5 is an exemplary screen including personal information about a user stored in an electronic wallet, in accordance with one embodiment of the present invention;

FIG. 6 is an exemplary illustration of a scheduling component of an advertisement, in accordance with one embodiment of the present invention;

FIG. 7 is an exemplary illustration of a programming component of an advertisement, in accordance with one embodiment of the present invention; and

FIG. 8 is an exemplary illustration of how information is retrieved from ad and IPG databases, in accordance with an embodiment of the present invention.

### DETAILED DESCRIPTION

In one embodiment, the present invention is an improved interactive television system and method for t-commerce. A playback device including a first storage medium with pre-recorded content and an interactive advertisement related to the pre-recorded content stored on the first storage medium. When the pre-recorded content is played back, a trigger for the interactive advertisement is generated. The interactive advertisement is then displayed on the television system in response to the trigger. The user may be prompted to respond to the interactive advertisement. A transactional request from the user response is generated and transmitted through the television system to a remote site. Alternatively, (the entire or a portion of) the interactive advertisement may be stored in a database and retrieved from the database responsive to the trigger.

Although, in some embodiments described herein, the present invention may use an IPG as a platform with which to execute the innovations described herein, the invention is not IPG platform dependent. That is, for some embodiments of the present invention, it is not necessary that the user interacts with an IPG. Furthermore, for some embodiments of the present invention, it is not necessary that the interactive display system of an IPG be available on the user's television. That is, according to one aspect of the present invention, administering the t-commerce transaction by the television user is independent of any user profile information and is independent of the user's interactivity with, or even the existence of, an IPG.

In order to complete the t-commerce transaction, a back channel or return path would need to be integrated with the television, and/or the IPG. The back channel could be a two-way cable, pager network, telephone network, cellular telephone network, Internet, or other similar means of upstream communication from users to service providers, merchants, or other related third parties. Those skilled in the art should realize the significant investment in infrastructure (e.g., back channel, inventory, shipping, billing systems, etc.) that is necessary to enable such t-commerce transactions. A two-way interactive television system using pager transmitter and receiver is described in U.S. Pat. No. 5,812,931; and cable and Internet back links are described in U.S. Pat. No. 6,388,714 B1; the entire contents of which are hereby expressly incorporated by reference.

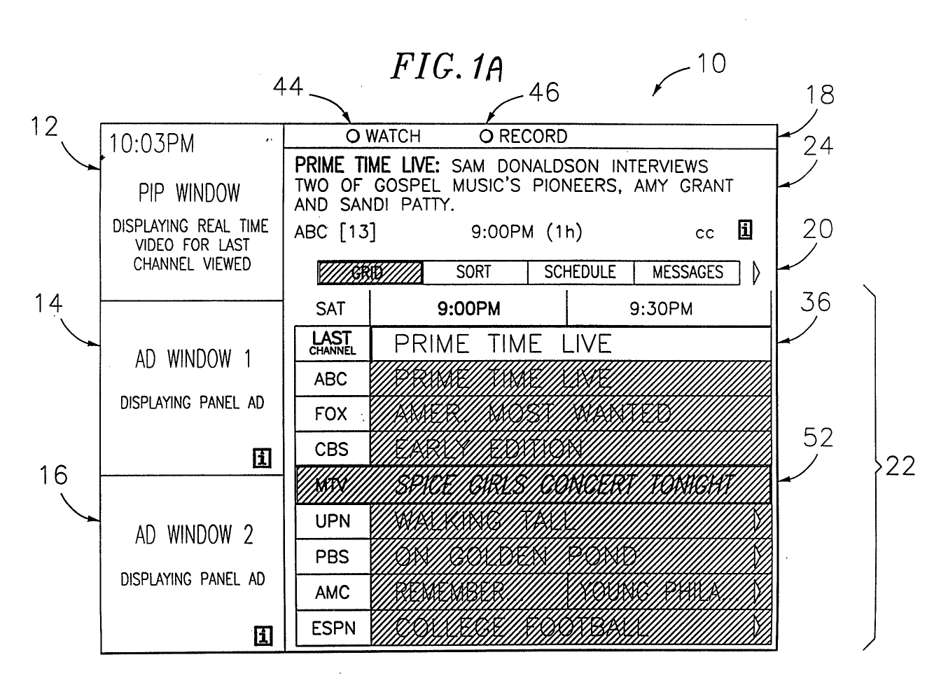

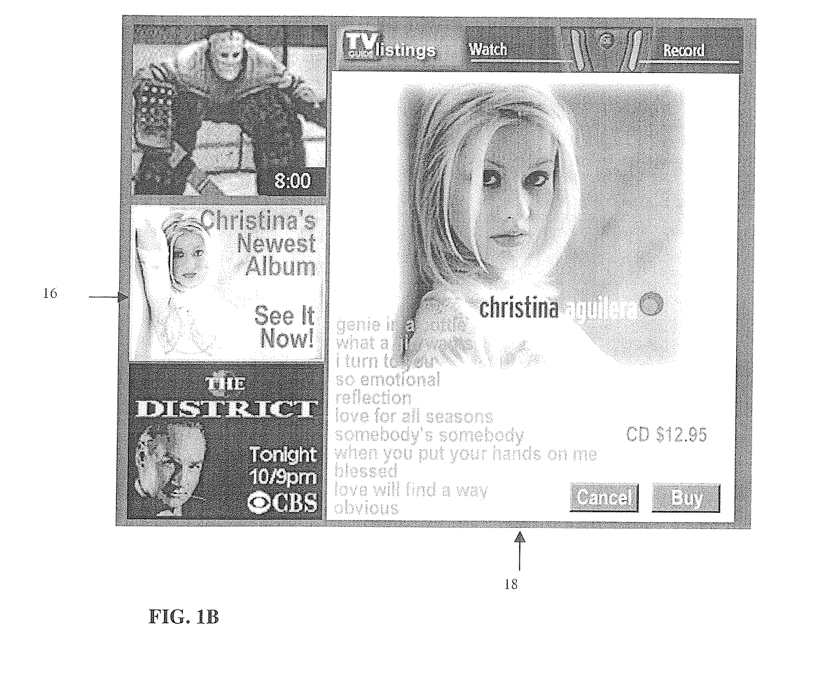

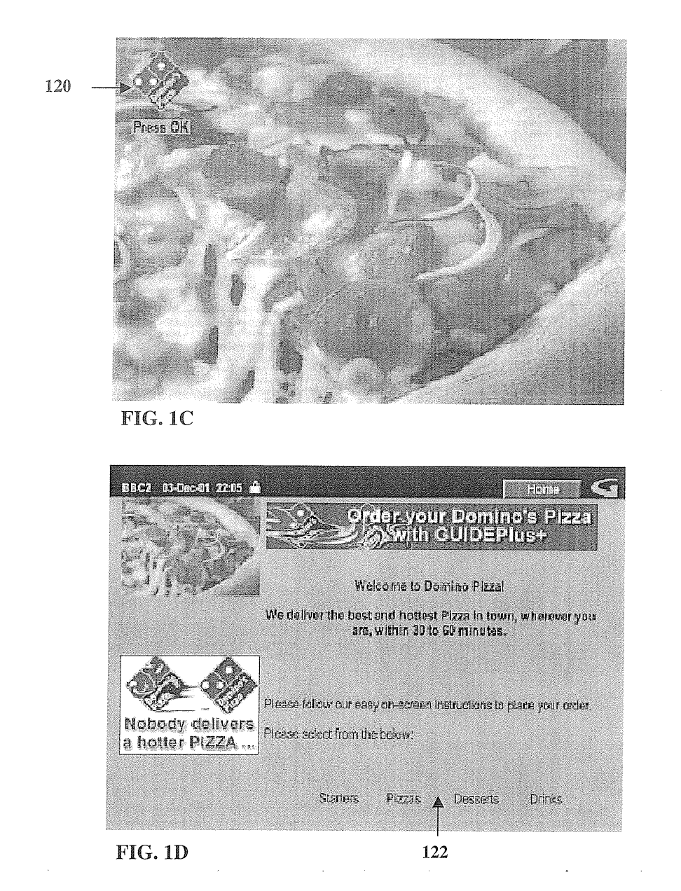

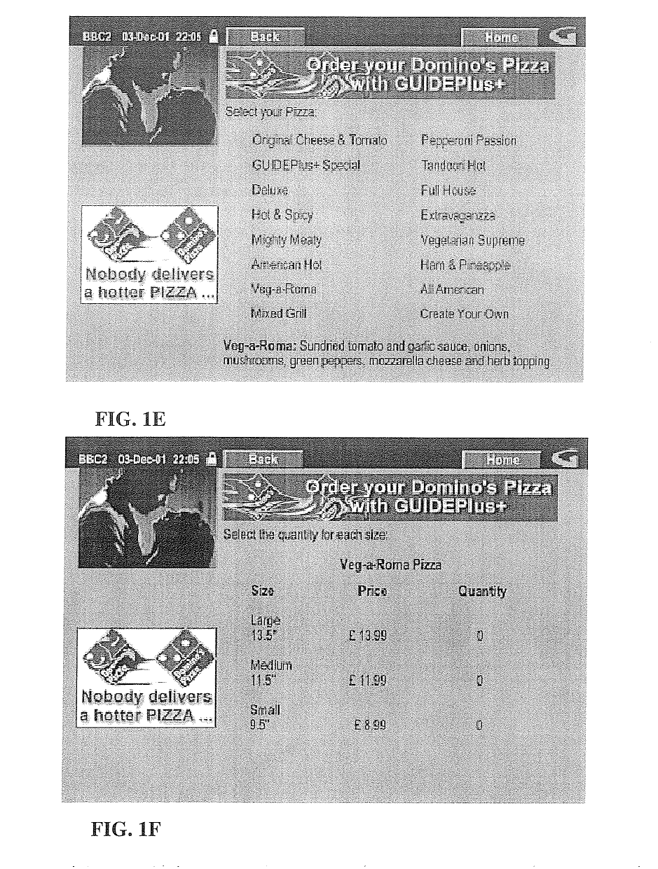

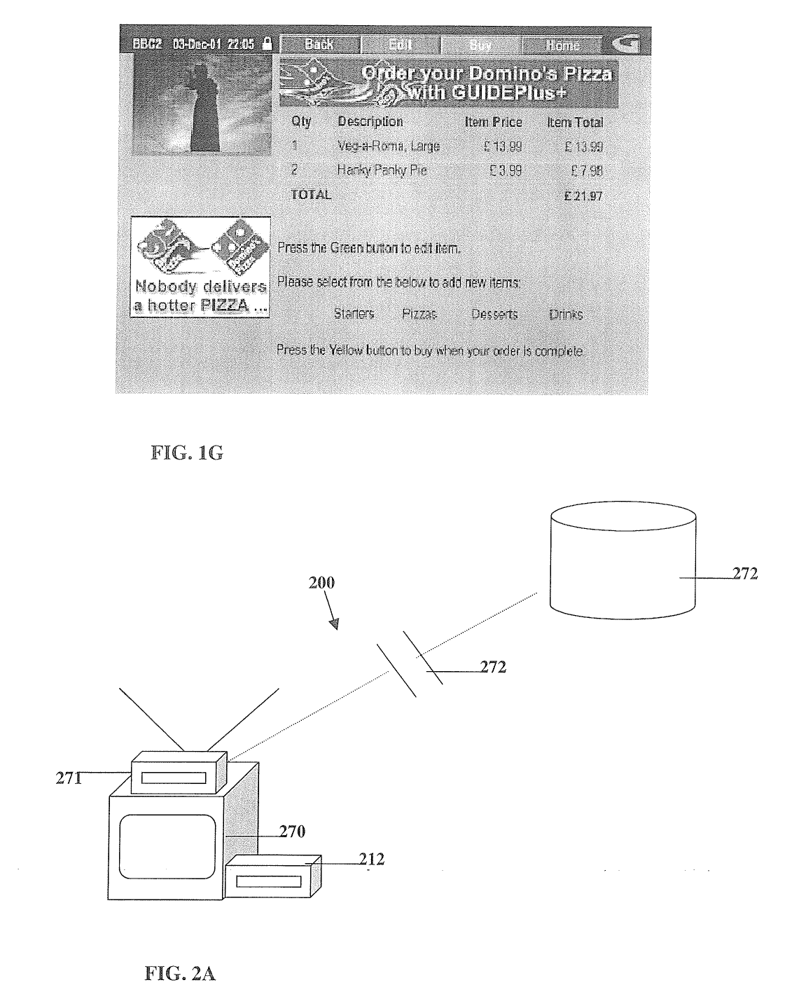

An exemplary IPG is illustrated in FIG. 1A. The IPG includes one or more interactive advertising panels 12, 14, and 16 through which interactive advertising or t-commerce opportunities can be delivered to users. The content delivered through the interactive advertising panels may be program or product related content. For example, advertising panel 14 may be utilized to advertise an upcoming program on one of the channels listed in the IPG. Additionally, the user may be prompted or have the ability to perform certain actions in relation to the program. For example, the user may have the option to set a reminder to tune to or record the advertised program at the time it is broadcast in the future.

Additionally, the user may have the option to block access to the advertised program using a parental control feature offered by the IPG. If the advertised program is a pay program (e.g., PPV, VOD, etc.), the user might also be prompted or have the ability to purchase the advertised program.

Additionally, advertising panels 14 and 16 may be utilized to advertise a product or service through the IPG. The product/service may or may not be related to one or more of the programs listed in the IPG. Using a remote control or other input device, a user may select the product/service advertising panel. Selecting the product/service advertisement provides the user with additional information about the advertised product/service. Additionally, the user may be prompted or have the ability to perform certain actions in relation to the product/service.

The user then has the option to purchase the advertised product. To complete the transaction, the user may be prompted to provide certain personal information (e.g., contact, credit card, billing information etc.). This information may be entered by the user at the time of the transaction, or alternatively, the user may select to use similar information that was previously stored within the system.

For example, in the IPG screen illustrated in FIG. 1B, the user has the option to purchase the advertised CD. To complete the transaction, the user is prompted to provide certain personal information (e.g. contact, credit card, billing information etc.). This information may be entered by the user at the time of the transaction, or alternatively, the user may select to use similar information that was previously stored within the system.

Alternatively, the t-commerce opportunity may be presented to a user outside of the IPG. For example, advertising or t-commerce opportunities may be presented to a user in connection with a currently broadcast television program or advertisement. Referring now to FIG. 1C, a full screen advertisement for a pizza is currently being broadcast on a television. During the full screen advertisement, an icon 20 appears on the screen to alert the user that an interactive advertising or t-commerce opportunity is available. Using a remote control or other input device, a user may select the icon. Selecting the icon will provide the user with additional information about the advertised product 22. In the current example, the user is presented with additional information and instructions on how to order a pizza directly through the television as illustrated in FIGS. 1D-1G.

In FIG. 1D, the user is provided with a list of various products (e.g., Starters, Pizza, Desserts, Drinks, etc.) that can be ordered from a merchant. Upon selections of a particular product (e.g., Pizza), more information (and choices) about the selected product may be displayed to the user, as shown in FIGS. 1E and 1F. An order summary including the item prices and the total price is displayed in FIG. 1G. Although, the information in FIGS. 1D-1G is displayed within an IPG, as mentioned above, the information may be displayed in a television mode without the use of an IPG.

The IPG is capable of collecting extensive information concerning a particular user, described as a user's profile.

Creation of a user's profile is disclosed in U.S. Pat. No. 6,177,931 B1 (“the '931 patent”), the entire content of which is hereby expressly incorporated by reference. Also described in the '931 patent is the utilization of a user's profile to customize the presentation to the user of advertisement. In the '931 patent, the presentation of advertising is customizable for every mode in which advertisement is presented to the user, including the customization of advertising presented as part of the IPG display and the customization of advertising delivered by the television tuner.

Referring back to FIG. 1A, a television screen display 10 is shown. Display 10 could be generated by a conventional television receiver with interlaced scan lines, by a VCR, by a PC monitor with progressive scan lines, or by any other type of video display device. In the upper left hand corner of the screen is a picture-in-picture (PIP) window 12. Below window 12 are Panel Ad Windows 14, and 16 (“Ad Windows”). Windows 12, 14, and 16 each typically occupy about 1/9 of the total screen area. The remainder of the screen area is typically occupied (moving from top to bottom of the screen) by an action key bar 18, a navigation bar 20, a grid guide 22 (“Grid Guide”), and an information box 24 (the “detailed information area). In the embodiment pictured in FIG. 1A, the position of the windows, and other user interface features, including the action key bar, navigation bar and Grid Guide, are fixed. In another embodiment of this invention, as is described further below, the position and size of the windows and other user interface features are customizable by the user.

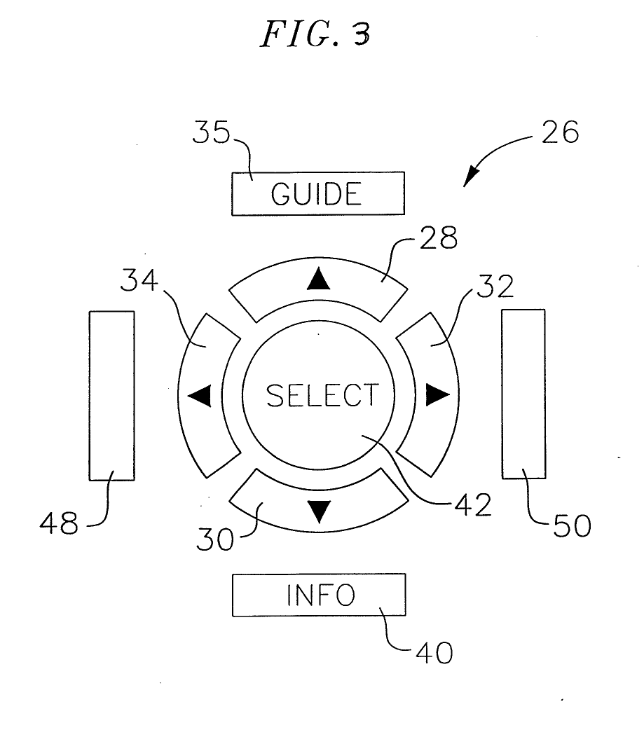

In FIG. 3 of the drawing, one embodiment of a remote controller 26 for activating the functions of display 10 is shown. Remote controller 26 could have other keys for activating the functions of a user video device, such as a television receiver, a VCR, or a cable box. Remote control 26 has up, down, right, and left arrows keys 28, 30, 32, and 34, respectively, for controlling the movement of a cursor 36 on display 10. Cursor 36 can select, i.e., highlight, any of windows 12, 14, or 16 by pressing arrow keys 28 to 34, any of the titles and channels in Grid Guide 22 by pressing arrow keys 32 and 34, or navigation bar 20 by pressing arrow keys 32 and 34. Windows 12, 14, and 16 are highlighted by adding a border around the window or changing the color of the border, if the border is permanent. The titles and channels in Grid Guide 22 and navigation bar 20 are highlighted by changing color.

Highlighting of windows and/or user selections from the Grid Guide and/or navigation and IPG on screen display components may be accomplished in a number of other ways. For instance, the border of a selected window, or the selected Grid Guide or navigation component, can be made to appear to flash. Another way to highlight a user selection is to make the selected window or feature appear to become brighter than the rest of the on screen display. Yet another way to highlight a user selection is to blur all portions of the on screen display, except for the user selected component. Still another way to highlight a user selection is to make all portions of the on screen display, except for the user selected component, appear transparent. Still yet another way to highlight a user selection is to add animation to the selected component. When a portion of the IPG is selected, the system issues graphic display commands to a video display generator to implement one or more of the desired functions.

The user enters the Guide Mode illustrated in FIG. 1A by pressing a “guide” key 35 and returns to the full screen Television Mode by pressing key 35 again or by pressing the “select” key. A real time television program is displayed in window 12. A translucent overlay of the PIP window 12 can display the title, channel (local number and/or station name), and status (locked or unlocked) of window 12 over the television program so the user can still see the entire image.

The PIP Window can be locked or unlocked. The “lock/unlock” mode is user controlled. To lock or unlock the PIP Window, the user can use a PIP button on the remote control device, or can highlight and press the Lock/Unlock IPG action button. The lock/unlock status is recorded and maintained until the status is reset by the user. That is, the lock/unlock status for the PIP Window in the IPG is maintained when the user leaves the Guide and later re-enters the Guide, including when the user turns off the television. If the user selects the “lock” status, the last channel to which the tuner was set in the PIP Window continues to be displayed regardless of the actions exercised by the user. In the unlocked status, the channel highlighted by cursor 36 in Grid Guide 22 is displayed if the Grid Guide is displaying currently telecast programs and the last currently telecast channel that was highlighted is displayed if the Grid Guide is displaying future programs.

There are generally three results to leaving the Guide, depending upon the way the user leaves the Guide. If the user, while in the IPG, wants to watch in full screen mode the program shown in the PIP Window, then the user can press the Guide button on the remote control device. If the user, while in the IPG, highlights a particular channel in the Grid Guide, and then presses the “select” button, the user will leave the Guide to view in the full screen mode the television program that the user highlighted in the Guide. If the user, while in the IPG, presses the “clear” or “cancel” button on the remote control device, then the user will leave the Guide and return to the television program that the user was watching immediately before entering the Guide.

Typically, an ad for a future telecast program is displayed in window 14. This ad is linked to the time and channel of the program in a memory so the user can watch or record the program automatically by pressing the blue left action button to watch the program, or the green right action button to record the program.

Typically, an ad for a product or service is displayed in window 16. This ad is linked to more information about the product or service in the memory so the user can read one or more pages about the product or service in window 16 by pressing an “info” key 40 one or more times. Alternatively, this ad is linked to the time and channel in memory that an infomercial about the product or service will be telecast so the user can watch or record the infomercial automatically by pressing “select” key 42.

Bar 18 displays a blue button 44 and/or a green button 46 with legends that depend upon the context of the information displayed on the screen. Remote controller 26 has corresponding keys 48 and 50, respectively, to activate the functions represented by blocks 44 and 46.

From window 12, 14, or 16 the user moves to grid guide 22 by pressing arrow key 32. (From grid guide 22 the user moves to window 12, 14, or 16 by pressing arrow key 34.) In grid guide 22 the user moves cursor 36 to highlight one of the nine tiles in which channel and title are displayed by pressing arrow keys 28 and 30. The user can view program listings scheduled at future times by pressing keys 32 or 34 to move horizontally about the Grid.

From grid guide 22 the user moves to navigation bar 20 by pressing arrow key 28. Initially, the center button is highlighted. To highlight a different button, arrow key 32 or is pressed. To enter the screen represented by the highlighted button, “select” key 42 is pressed.

In grid guide 22 details about the program represented by the highlighted tile are displayed. If more information is available an icon is displayed and such information is displayed in the area occupied by grid guide 22, instead of the grid guide by pressing “info” key 40. To return to the grid guide, “info” key 40 is pressed again. After an action button has been pressed or an icon on navigation bar 20 has been activated, an instructional prompt may be substituted for the program information in information box 24.

In addition to the tiles representing television programs, a virtual channel ad can be displayed in grid guide 22 on a tile 52. A virtual channel ad may promote, for instance, a current or future television program. Such a virtual channel ad for a television program is linked to the time and channel of the program in RAM so the user can watch or record the program automatically by pressing “select” key 42 in the manner described in the referenced application. More than one virtual channel ad may be stored in RAM, but preferably only one such ad is displayed at a time.

In some embodiments, data for the IPG schedule, and/or supplemental information relevant to the program listings, and/or advertising data, can be downloaded to the memory resident at the user's television system. In one embodiment of the download data system, the user asks the IPG to make certain types of information available; the IPG uses an index of where to find the information and automatically connects to the appropriate data source and will download the information. Data for the IPG schedule, and/or supplemental information relevant to the program listings, and/or advertising data, can be downloaded from various sources. In one embodiment, data is downloaded from the Internet. In other embodiments of the download data system, the user is asked to tune to a particular channel at a particular time if the user is interested in accessing and downloading particular types of information.

Not all embodiments require that data be downloaded to the IPG memory. In one embodiment, the IPG scheduling data, supplemental data and/or advertising data and the software to format, display, and navigate the IPG scheduling data, supplemental data and/or advertising data is accessed by the user's television system through a direct link between the user's television system and the Internet.

In one embodiment of the above-described direct-link to the Internet, the user's television is connected to the Internet by telephone line via modem, cable modem, by other two-way communication device, including wireless modem communication devices, and/or by other conventional methods of communicating with the Internet. The initial connect web site address may be supplied, for instance, through information transmitted to the user's television over the VBI. The user may also be provided with a selection of multiple IPG Internet web sites. The user uses the remote control device to select one of the IPG Internet web sites

The user's television system is programmed to emulate a computer having on-line access to the Internet. Once the connection between the user's television system and the Internet is made, the user has two-way communication with the on-line Internet service providers (e.g., of the IPG related information). The user can then navigate through the IPG. Furthermore, in one embodiment, in which keyboard user interface is available, the user can enter chat rooms or other interactive services.

In one embodiment, when the user highlights a particular program in the Guide, the Ad Window, or a Virtual Channel Ad Slot, or makes other access requests to detailed program-related information, the IPG connects the user with an external database of information, such as with a particular web site on the Internet. The user can instruct the IPG to connect the user with detailed specialized information guides/data services, such as sports, news, or other guides/data services. In one embodiment, the linking to the external data source is accomplished by storing a web site address with the Ad Window or Virtual Channel Ad Slot advertisement in the memory of the user terminal.

In one embodiment, the user can access the Internet to send and receive e-mail. In another embodiment, the television terminal is separately addressable, and the head end controls e-mail traffic between users on its network. In one embodiment, to facilitate two-way transmission or a toll free number is used as a back link. E-mail can then be sent to the appropriate user through the VBI to the user's separately addressable television.

In a Recording Function, the user instructs the IPG what programs to add to the Record List, which is the list of programs and related programming schedule information, for programs that the user wants to have recorded. The user can identify the frequency/regularity with which the user wants to record each program listed in the Record List.

The user can enter the Recording Function in a number of ways. The user can press the “Record” key, if there is one, on the user's remote control device. Alternatively, the user can “press” a “Record” action button on the IPG display. One embodiment of the present invention provides the user with the option of recording a particular program “regularly.” The “regularly” option can be selected when the user highlights a particular program title on the IPG Grid Guide. User selection of the “regularly” option instructs the VCR control system (or other recording devices) to record the particular title on the selected channel at the selected time slot any day of the week that the program is telecast. If a telecast of the selected title is preempted by another program, the new program is not recorded. The change in the telecast schedule is determined by comparing the title of the selected program to the title of the program actually telecast. In one embodiment of the invention, it is assumed that the title of the program actually telecast is carried in the vertical blanking interval of the television signal. When the user has instructed the IPG to “regularly” record a particular program, if the selected program is preempted by another program, the preempting program is not recorded and the IPG displays a message notifying the user that the selected program was preempted and was not recorded.

In one embodiment, the user can instruct the IPG to record programs on recordable Digital Video Discs (DVDs), hard disks, or other high capacity recording mediums. Because of the extended storage capacity of DVDs, the user can instruct the IPG to record and index an extended period of programming.

For instance, the user can instruct the IPG to record and index with certain numbers, e.g., 4 hours of CNN news broadcasts. When the user is ready to view the DVD (or hard disk) recording, the IPG displays the index on screen. The user can then select to view either the entire recording, or only those portions of the recording in which the user is interested. Interactive advertisements (or pointer to the interactive advertisements) may be recorded with programs. The interactive advertisements are then presented to the user at the time of replaying the recorded program.

In one embodiment, program-level indexing of recorded programs is created. In another embodiment, intra-program indexing is created by using information transmitted in the VBI of the video transmitted. In this embodiment, a recording of CNN would likely show indexing breakdowns that include themes, such as “International News,” “National News,” “Sports,” “Entertainment,” “Business & Finance,” and “Weather.”

The IPG user interface (UI) screen provides for multiple viewable “windows.” One window presents the IPG Grid Guide. Another window presents the picture-in-picture (PIP) window on which the currently tuned program is displayed. Another window displays advertising information (the “Ad Window”). Advertising may be in the form of graphics and textual information. Alternatively, advertising may be in the form of video display. In one embodiment, the Ad Windows are interactive.

As described further below, the user can also highlight the Ad Window. Doing so will cause additional text describing the product to be displayed in the detail box are of the IPG Grid Guide. If the Ad Window displays information about a particular product or service, pressing a record button will instruct the IPG to record an infomercial, to the extent that one is scheduled for a future time. Alternatively, the Ad Window can display information about a future-scheduled television program or about a series of programs to be telecast over a period of time. In that case, pressing a record button will instruct the IPG to record the future-scheduled program. Alternatively, the user can designate the program for the Watch List.

In one embodiment, the position and size of the windows and other user interface features are customizable by the user. In one embodiment, the IPG creates special translucency visual effects. To create the translucency effect, the system alternates the display format pixel by pixel, wherein one pixel is the color of the overlay and the next pixel is transparent. In one embodiment, the IPG is capable of formatting on-screen notifications (messages) to the user and displays the notification to the user. On-screen notifications can be used to alert the user to any number of possible items of information. For instance, the IPG can notify the user that a product is available to be purchased, or that the IPG will begin recording a particular program within a certain amount of time, e.g., 2 minutes. The record notification could further ask the user whether to switch the cable box or other tuner (e.g., a satellite receiver) to record the program. If the user indicated that the user did not want the IPG to switch to the cable box to record the program, then the IPG would delete the program from the record list.

Another example would be to notify the user that a program that may be of interest (e.g., as determined from analyzing the User's Profile) will be broadcast on another channel within a certain amount of time, e.g., 2 minutes. The IPG could then ask if the user wants to view the program on the other channel. If the user indicates that the user wants to watch the program on the other channel, then the IPG will automatically tune to the other channel at the appropriate time. Alternatively, the IPG could ask the user if the user wants to record the program on the other channel and could then record that program at the appropriate time if the user answers affirmatively.

If the television is in television mode, the notification is displayed on-screen. The notification can be displayed in a number of ways, including: 1.) a complete screen overlay; 2.) a partial screen overlay; 3.) The real time program video is automatically changed to a PIP format, and the notification is displayed outside of the PIP window; 4.) The real time program video is automatically changed to a PIP format, and the notification is displayed inside of the PIP window; 5.) as a “watermark” somewhere on-screen; 6.) an on-screen icon is displayed which can be “pressed” by the user using the navigation keys on the user's remote control device, and which, if pressed, displays the notification in one of the above formats; 7.) the program video is compressed slightly to fit in some percentage, e.g., 90%, of the top of the screen, and the notification is displayed as a horizontally-rolling message at the bottom of the screen; and 8.) the program video is compressed slightly to fit in some percentage, e.g., 90%, of the bottom of the screen, and the notification is displayed as a horizontally-rolling message at the top of the screen.

If the television is in some mode other than the television mode, the IPG can notify the user through some modification of one of the above-described formats. For instance, if the television is in the Grid Guide mode in a PIP format, then the IPG could use any of format numbers 1.), 2.), 5.), 6.), 7.), 8.) or, the IPG could notify the user by displaying the notification in the Ad Window, a virtual ad channel slot, in the detail information window, or in a horizontally-rolling message at the top or bottom of the screen.

The IPG is also capable of supporting parental control of the IPG display. In one embodiment, the Parent user initially enters the Parental Control Function during initial IPG setup procedures. In the IPG setup procedure, the Parent identifies all users of the television, and assigns individual user Identifiers. The Parent user also establishes a password for said Parent user. U.S. patent application Ser. No. 09/310,433, filed on May 12, 1999 (“V-CHIP Plus+: In-Guide User Interface Apparatus and Method”) describes Parental Control setup procedures for the identification of individual users and initialization of password protection, the entire content of which is hereby expressly incorporated by reference.

In the Parental Control Function, the Parent selects the channels and programs that can be visible in the Grid Guide for a particular user and selects channels and/or programs that are to be blocked from viewing. Child users, as identified during setup procedure, will view a simplified Grid Guide and will be blocked from viewing the programs so marked by the Parent. In one embodiment, individual users are identified by user ID and password. In another embodiment, individual users have different remote control devices, the use of which is also password protected.

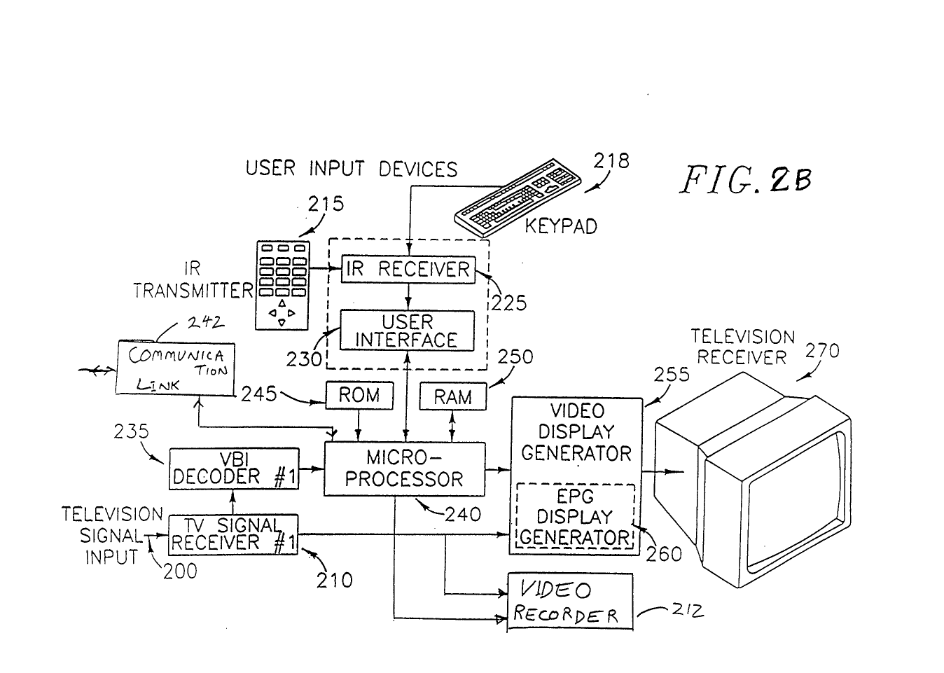

FIG. 2A depicts a television system 200 according to one embodiment of the present invention. In this embodiment, the television system includes a television 270, a set-top box (STB) 271 operatively coupled to and in communication with the television, and a playback device 212 operatively coupled to and in communication with the television. In the example of FIG. 2A, the playback device 212 is a DVD player. The STB 271 is operatively connected to or in communication with a central service provider 273 through either a one-way or two-way broadcast system through a return path or back channel 271. In a one-way broadcast system, a separate back channel or return path is necessary to transmit user responses, such as transaction requests, upstream to the central service provider or other third party. In one embodiment, the STB preferably includes the necessary hardware and/or software to enable an IPG. Using this IPG software and hardware, advertising and t-commerce opportunities can be presented to the user with real-time or currently broadcast television programs as previously described.

FIG. 2B is an exemplary block diagram of a television system in more detail, according to one embodiment of the present invention. Based on a pre-established criteria, the head end delivery provider inserts a trigger command in the VBI of one or more television signals. Optionally, the trigger command is accompanied by a duration, expressed, for instance, in seconds. The pre-established criteria for the VBI trigger command insertion can be based on, for instance, a schedule of advertisements as identified in a channel, program and advertisement scheduling table. Alternatively, the head end delivery provider interrogates the outgoing signal and detects a particular event, such as, for instance, a change from television programming to commercial advertising. The trigger command instructs the receiving television set to initiate specific functions, as described below. This trigger along with the interactive advertisement and the program may be recorded in the video recorder. When the program is played back, the trigger is activated and responsive to trigger condition(s), the interactive advertisement is then displayed on the screen.

As shown in FIG. 2B, the television receiver 210 receives the input television signal 200 by a tuner. The television receiver sends the television signal to the VBI decoder 235 to decode the information carried in the VBI of the signal. The VBI decoder 235 then sends the decoded VBI information to the microprocessor 240 for analysis. The user interacts with the system using a remote controller (IR transmitter) 215 and/or a keypad 218. Other user input devices such as voice recognition devices may also be used. The IR receiver receives user's commands and passes the commands to the user interface unit 230. The user interface unit then passes the commands to the microprocessor 240 to process the input commands. The video recorder 212 can be instructed by the microprocessor to record television programs at the specified time. The video recorder 212 plays back the recorded program and a trigger gets activated. Based on the trigger condition, the microprocessor displays the (recorded) interactive advertisement on the screen.

During a full screen television mode, when a pre-recorded program is played back, an icon may appear on the screen to alert the user that an interactive advertising or t-commerce opportunity is available. Using the remote control or other input device, the user may select the icon. Selecting the icon provides the user with additional information about the advertised product and means for ordering the advertised product. For example, the user may be presented with additional information and instructions on how to order a pizza or a camera directly through the television.

Consider then, a particular user's television set 270 that is displaying a pre-recorded program. When the microprocessor 240 receives a trigger command in the recorded program, the microprocessor causes the video display generator 255 to display special graphics with which the user can select to interact with a displayed advertisement. Alternatively, the special graphics may be stored in the RAM and be displayed in response to a user command. When the microprocessor receives a BUY command from the user, the system dials a phone (or sends a wireless message, or an Internet message) through the communication link 242 to an order center (or a merchant) and orders the product or service. If the trigger command is accompanied by a duration component, then the special graphics with which the user can interact to order a product is displayed for the duration expressed in the trigger command.

The trigger instruction of the present invention can also be implemented if the user is in the IPG mode. In this application, IPG mode refers to the operation of a television whereby the user has activated the IPG. In this mode, the special graphics with which the user can interact to select a product/service to be ordered is displayed in the IPG by the IPG display generator 260. Similar to the previously-mentioned embodiment, when the system receives the trigger command during the play back of a recorded program, it displays the recorded interactive advertisement for a product or service. If the user selects the BUY command, the system then sends a message through the communication link 242 to the order center and orders the product/service. In this embodiment, the special graphics is generated by the IPG display generator 260 in a location within the displayed IPG (e.g., a panel ad area).

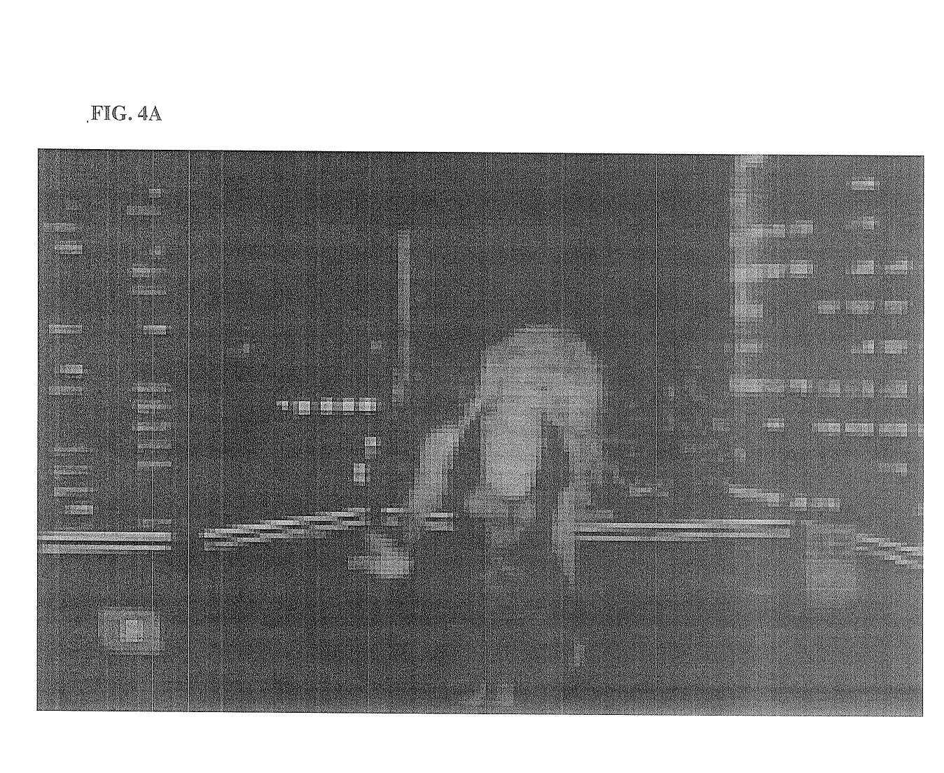

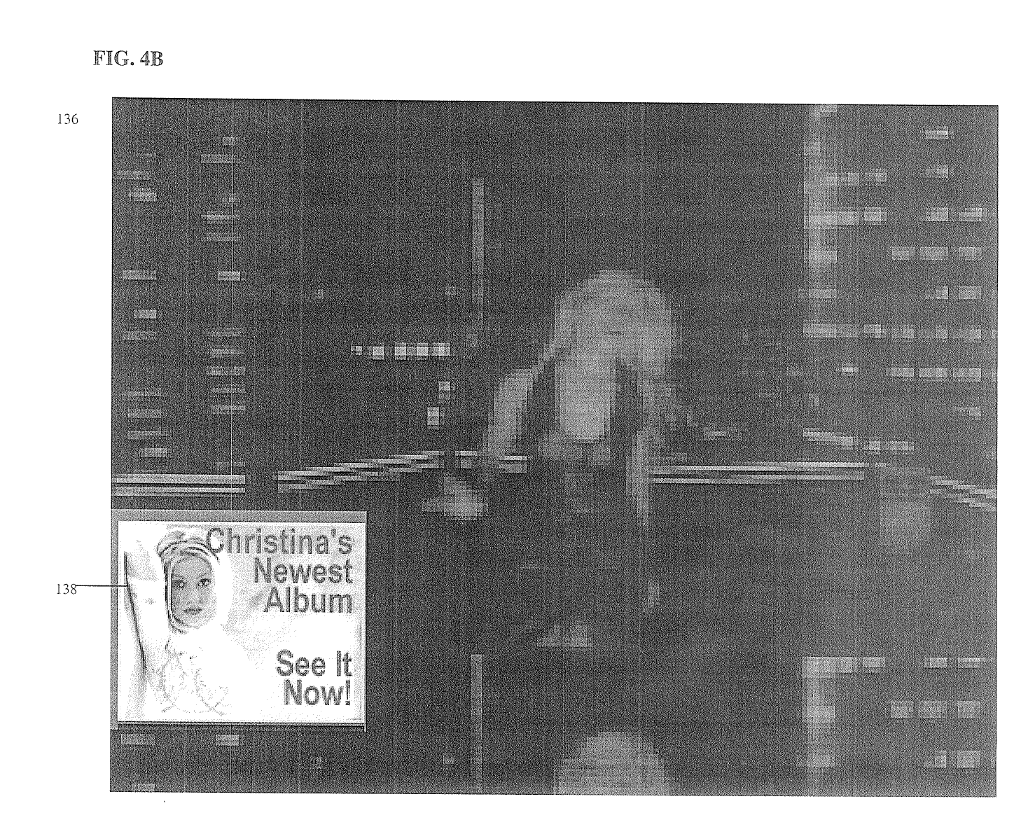

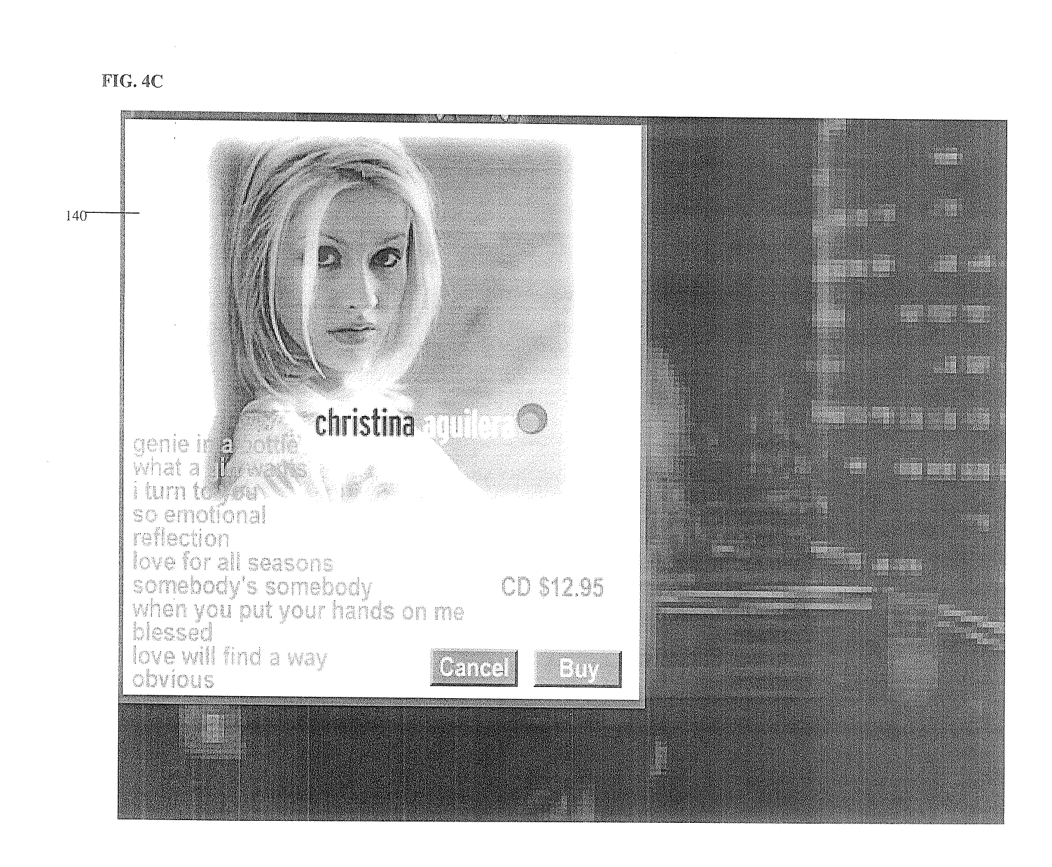

FIGS. 4A-4C depict a pre-recorded music video stored on a DVD. Additionally, one or more interactive advertisements 140 are stored on the DVD. In one embodiment, the interactive advertisements are contextually related to the content stored on the DVD, although those skilled in the art should realize that contextually unrelated interactive advertisements may additionally or alternatively be utilized. The interactive advertisement may be triggered and displayed on the television screen at any time when the music video on the DVD is played by DVD player 212 and displayed on the television screen. In one embodiment, an icon or message 138 notifying the user about the presence of the interactive advertisement 140 is displayed on the screen, as shown in FIG. 43.

The icon may comprise text, graphics, audio or video or any combination thereof. In the present example the icon and interactive advertisements are presented as overlays on top of the recorded content. Those skilled in art should realize that other layouts or designs for the user interface of the interactive advertising may additionally or alternatively be utilized. Those skilled in the art should also realize that any appropriate advertising message may be delivered through the interactive advertisement. For example, in the DVD example listed above, the interactive advertisement may identify a list of other similar or related DVDs for purchase.

In one embodiment, the interactive advertisement also includes a trigger that instructs the system when, where and/or how to present the interactive advertisement to the user. Those skilled in the art should realize that the trigger might have one or more attributes that define when, where and/or how the interactive advertisement is presented to the user. For example, these attributes may include any text to be presented along with the interactive advertisement, the time or range of times at which the interactive advertisement should be displayed, the date and/or time after which the interactive advertisement should be ignored, the cycles of interactive advertisements that should be displayed in connection with the recorded content, etc. Other similar attributes may be understood by reference to the Advanced Television Enhancement Forum (ATVEF) specification, the entire content of which is hereby expressly incorporated by reference.

Using the remote control or other input device, the user may select icon. Selecting the icon provides the user with additional information about the advertised product through an interactive advertisement 140, as shown in FIG. 4C. In the present example, the interactive advertisement is for a compact disc of the artist featured in the music video 136 stored on the DVD. In one embodiment, the interactive advertisement includes a BUY or other similar button, icon or prompt that allows the user to immediately and in real-time purchase the advertised product. Selecting the BUY button initiates a transaction request that will be send upstream to the central service provider through the return path to allow the user to purchase the advertised product. Those skilled in the art should realize that one or more navigational or informational screens may be provided to the user during the transaction process to confirm the transaction request.

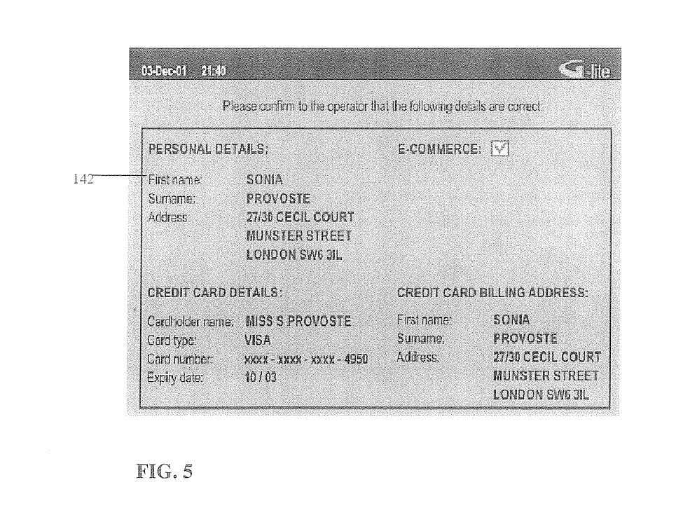

Specifically, the transaction request may include an indication of the product/service to be purchased and the user desiring to purchase the product/service. In one embodiment, each interactive advertisement has a unique product/service identification for the product/service being advertised. This unique product/service identification may be pulled from the interactive advertisement and combined with a unique user identification to form a complete transaction request. The user identification may include personal information about the user stored in an electronic wallet 142 (e.g. name, address, telephone number, credit card information, PIN, etc.), as shown in FIG. 5. Some or all of this personal information is preferably already stored in the STB for use in connection with advertising and t-commerce opportunities presented to the user through the IPG in connection with real-time or currently broadcast television programs. Typically, this personal information is provided by the user upon initial registration of the STB, either directly through the STB or indirectly, by way of a third party, through the telephone. In two-way enabled television systems, the transaction request may be directly submitted through the system to the central service provider. Alternatively, if necessary, the telephone system may be used as a return path to transmit the transaction request to the central service provider. Using the product and user information contained in the transaction request, the central service provider can process and fulfill the user's transaction request.

As described in the '931 patent (mentioned above), a user's profile is created by collecting information about a user. The IPG requests that the user provide certain profile information, including but not limited to: the user's zip code; television, cable, and satellite services to which the user subscribes; the length of said subscriptions; the type of television; the age of the television; where the television was purchased; the user's top favorite channels; the user's favorite types of programs; and the times during which the user is most likely to watch television. If the user declines to provide this information, the IPG will attempt to “learn” the information as described below.

In one embodiment, the IPG is capable of distinguishing between individual users and develops individualized profiles. For instance, in one embodiment, each user has an individual PIN or other identification number. In another embodiment, each user uses an individualized remote. In yet another embodiment, there is an absence of a way to distinguish one user from another. In that case, the profile is developed for the “family.”

Every time the user interacts with the IPG or the television, the IPG records the user's actions and the circumstances surrounding those actions. For instance, when the user changes channels, the IPG records, among other things, information about the first channel, the changed-to channel, the time that the change was made, the identification of the programming that was displayed on the first channel, the identification of the programming that was displayed on the changed-to channel, the time of the change, the identification of any advertisement that was displayed on the first channel at the time of the change, the identification of any advertisement that was displayed on the changed-to channel, and whether the user changed channels while in one of the IPG modes, as opposed to being in the television mode. The IPG also records every instruction by the user to record or watch a program, whether the instruction is Once, Daily, Weekly, or Regularly. The IPG also records whether the user changes the volume of the television audio, and if so, what circumstances surrounded the change in volume. If the user changes channels while in one of the IPG modes, then the IPG records information about what was displayed in each of the windows of the IPG UI before and after the change.

Additionally, the IPG records information when there is an absence of interaction between the user and the television or the IPG. For instance, the IPG records whether a user continues to view an advertisement rather than changing channels. The IPG calculates and records the entire duration of the time that the television is on in any particular day.

The IPG also records information surrounding the user's interaction with external sources of information, such as the Internet. For instance, the IPG records each search query criteria initiated by the user, the Search Engine used to make the search, the items selected by the user from the search response, interaction by the user with Internet sites, and user interactions with the IPG during the same time-frame as the user interacts with the Internet.

An alternative to the above-described individual user profile information collection would be to provide on-screen survey queries. That is, the IPG could display an offer on-screen that would tell the user to call a toll-free number for the purpose of reading an on-screen encrypted number for the survey in exchange for a gift certificate. The offer could be made only to users watching a particular program or particular advertisement at a particular time. Survey responses would provide useful information further survey customization, customizing the guide, and targeting advertising.

As with television programming data, the television system may also receive advertisement data in packets. The advertisement data is then stored in an advertisement (ad) database. The received advertisement may be recorded with a program and then displayed when the recorded program is played back. Alternatively, a pointer pointing to the stored advertisement is recorded with the program and when the recorded program is played back, the pointed stored advertisement is retrieved from the ad database and displayed on the screen The advertisements typically relate to general products, services, future television programs, and the like. The advertisement data packets, according to one embodiment of the invention, comprise a scheduling component and a program component.

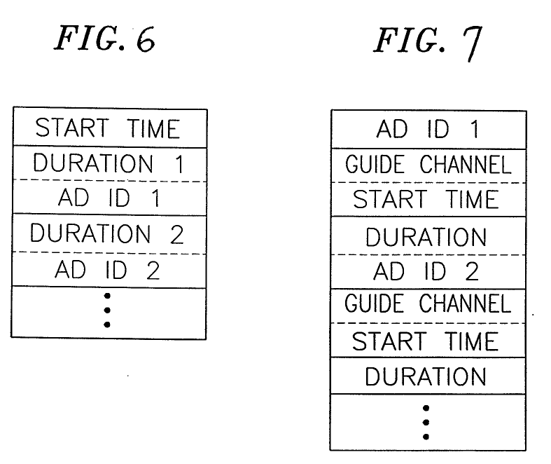

The two components of the advertisement data packets are transmitted by an information broadcasting system. FIG. 6 is an exemplary illustration of the scheduling component. As illustrated in FIG. 6, the scheduling component includes a Start Time and 24 hours worth of ad schedules. The Start Time is the time in which the advertisements are to be displayed, and can be any time during the day. Generally speaking, however, the Start Time of the ads is 12:00 am. Following the Start Time is a Duration field and an Ad ID for each scheduled ad. The Duration field indicates the period for which a particular ad is to be displayed. In one embodiment, ad durations may range from 5 minutes to 24 hours. The Ad ID is utilized to access the ad copy (text & graphics) for a particular ad when the recorded program is played back.

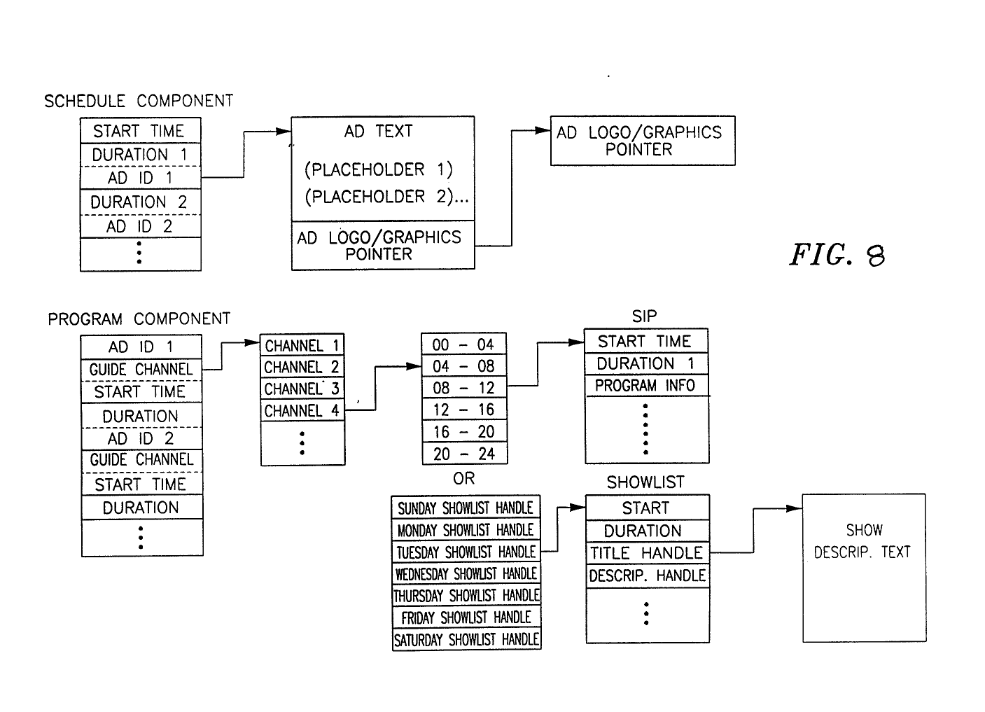

In addition to the schedule component, the information broadcasting system also transmits a program component. The program component allows the television system to link to an advertised show. FIG. 7 illustrates a program component according to one embodiment of the invention. As illustrated in FIG. 7, the program component includes an Ad ID, a Guide Channel, Start Time, and Duration. The Ad ID allows the Guide Channel, Start Time, and Duration fields to be associated with a particular advertisement. The television system utilizes the Guide Channel to find the program schedule information for that channel. The Start Time and Duration fields are used to find a particular program broadcast by the channel.

According to one embodiment, the Guide Channel, Start Time, and Duration information are transmitted in the order the advertisements are scheduled. For instance, the first Guide Channel, Start Time, and Duration are associated with the first scheduled advertisement, the second Guide Channel, Start Time, and Duration are associated with the second scheduled advertisement, and so forth. Thus, according to this embodiment, the information broadcasting system need not transmit the corresponding Ad IDs.

FIG. 8 is an illustration of how information is retrieved from the databases (e.g., the ad and IPG databases). Beginning at the Start Time or upon receiving a trigger in the play back of the recorded program, the television system retrieves an Ad ID (Ad ID1 in this example), and locates the corresponding ad copy in the advertisement database. Each ad copy includes a text field and a pointer to a logo/graphics. The text field contains special tags which serve as placeholders for particular values. These placeholders might reserve space in the ad copy for the air time of an advertised show, an episode s title/description, or any other information available from the IPG database. Accordingly, advertisements may be modified based on the information stored in the IPG database, and it no longer becomes necessary to create new advertisements for different time zones or different episode descriptions.

The ad entry further includes a pointer to an ad logo, if appropriate. The ad logo includes a graphics file of a logo (e.g., the NBC logo) or any other graphics data that is to be displayed with the ad. The television system utilizes the program component to link advertisements to the corresponding television programs. This allows the television system to insert the appropriate information into the placeholders of the text of an advertisement. In addition, the linking of programs to advertisements (about a television program) allows a user to schedule a show for watching or viewing directly from the advertisement while playing back another pre-recorded program.

In linking advertisements to corresponding television programs according to one embodiment of the invention, the Guide Channel of the program component is used to locate a map of pointers for a particular channel, each pointer corresponding to a show information package that contains data for a four-hour block of television programming for that particular channel. The Duration field allows the system to retrieve a particular program information within in a show information package. When the particular program is located, the television system retrieves values necessary for inserting information into the placeholders of the corresponding advertisement. For instance, the program description may be retrieved from the show information package and inserted into a program description placeholder within the ad. Furthermore, the time in which the advertised program is to air may be retrieved and inserted into an air-time placeholder.

According to one embodiment, the IPG database contains programming information for an entire week. In this case, the Guide Channel is used to locate a showlist handle table with a handle to a showlist for a particular channel for the current day. The Start Time and Duration fields are used to locate the appropriate show description entry.

In another embodiment of the invention, the program component is not sent as a packet, but is created within the television system based on information transmitted with the advertisements in the scheduling component. According to this embodiment, the information broadcasting system transmits with the scheduling component, the title of the program being searched for, a time range in which the show will be broadcast, and a network station indicator for finding the network station broadcasting the program. For instance, the ad may contain instructions to “link to NBC show ‘Friends’ on Thursday evening.” With this information, the television system searches the IPG database for the show ‘Friends,’ and creates the program component for the corresponding ad. In this way, a television system capable of tuning to multiple NBC affiliates would select the channel of the NBC affiliate which the television system is in fact tuned to.

While the illustrated embodiments of FIGS. 6-8 have been described in connection with modifying time and program descriptions for an advertisement of a future television program, it will be appreciated that other types of advertisement information may be modified if desired. Additionally, the advertisement linked with the programs may also be linked with the user profile and a database of different merchants in a similar way. This way, different ads can be displayed to different users during play back of a pre-recorded program, based on the users respective user profiles.

Information related to the advertised product and/or service, such as price, telephone number, point of sales, web site address, dates of promotions, and the like, may also be modified based on the information stored in the database. For example, if the web site address of a product merchant is changed, only the new web site address needs to be transmitted and then inserted to the appropriate field of the stored advertisement when it is displayed on the screen. Alternatively, the web site address may be retrieved form the database and combined with a portion of the stored advertisement. In another example, the advertisement rotation information such as starting time and duration, and frequency of display can be retrieved from the database and combined with the advertisement content stored in the ad database for displaying on the screen.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

For example, although the present invention is described and illustrated using a DVD, any other consumer electronics device may be used. For example, although the present invention has been described and illustrated using a DVD as the storage medium and a DVD player as the playback device, those skilled in the art should realize that it may additionally or alternatively be a VCR, CD-R(W), DVD-R(W), PVR, PC or other similar consumer electronics device depending on the particular storage medium preferred by the user. Additionally, although the STB and playback device are described and illustrated as two distinct components of the television system, those skilled in the art should realize that additionally or alternatively all of the necessary hardware and software for facilitating the present invention may be incorporated into a single consumer electronics device. Furthermore, although only one interactive advertisement was described and illustrated, those skilled in the art should also realize that multiple interactive advertisements may be stored for presentation to the user. More specifically, using user preferences or other user information, customized or targeted interactive advertisements may be delivered to the user using the present invention.

1. A method for facilitating transactions by a user of user equipment including a playback device, the method comprising:
storing program content on a first storage medium, wherein the program content contains an embedded trigger command to display an interactive advertisement;
storing on the first storage medium an advertisement identifier associated with an interactive advertisement;
generating a trigger from the embedded trigger command;
retrieving the interactive advertisement from a plurality of interactive advertisements based on the stored advertisement identifier, the plurality of advertisements being located remotely from the user equipment;
displaying the selected interactive advertisement on the user equipment in response to the trigger when the stored content is played by the playback device;
responding to the displayed advertisement by the user;
generating a transaction request from the user response to the displayed advertisement; and
transmitting the transaction request to a remote site.

2.-7. (canceled)

8. The method of claim 1, further comprising storing a user identification within the user equipment and generating the transaction request from the user response and the user identification.

9. The method of claim 8, wherein the storing a user identification comprises storing user identification in a second storage medium distinct from the first storage medium.

10. The method of claim 8, wherein the storing a user identification comprises storing a user identification including personal information of the user in an electronic wallet.

11. The method of claim 1, wherein the interactive advertisement is related to the program content.

12. The method of claim 1, wherein the interactive advertisement is targeted to the user.

13. The method of claim 1, wherein the first storage medium is selected from a group consisting of floppy disk, hard disk, optical disk, flash memory, DVD, CD, and video tape.

14. The method of claim 8, wherein the user identification is stored in a memory in a consumer device selected from a group consisting of set up box, television set, video cassette recorder, CD-R(W), DVD-R(W), personal video recorder, and personal computer.

15. The method of claim 1, further comprising providing a return path from the remote site for the transmitted transaction request.

16. The method of claim 1, further comprising storing the trigger in the first storage medium.

17. The method of claim 2, wherein the prompting is displayed in a full screen television mode.

18. The method of claim 2, wherein the prompting is displayed in an interactive program guide.

19.-35. (canceled)

36. A system for facilitating transactions by a user comprising:
first storage medium for storing program content, and an advertisement identifier associated with an interactive advertisement, wherein the program content contains an embedded trigger command to display an interactive advertisement; and
microprocessor coupled to the first storage medium and configured to:
play the stored program content on a playback device coupled to the first storage medium,
generate a trigger from the embedded trigger command;
retrieve the interactive advertisement from a plurality of interactive advertisements based on the stored advertisement identifier,
display the selected interactive advertisement on a display screen coupled to the playback device in response to the trigger when the stored program content is played by the playback device,
generate a transaction request from a user response to the displayed advertisement, and transmit the transaction request to a remote site.

37.-42. (canceled)

43. The system of claim 36, further comprising a user identification stored within the user equipment and wherein the microprocessor generates the transaction request from the user response and the user identification.

44. The system of claim 43, further comprising a second storage medium distinct from the first storage medium for storing the user identification.

45. The system of claim 43, further comprising an electronic wallet for storing the user identification including personal information of the user.

46. The system of claim 36, wherein the interactive advertisement is related to the program content.

47. The system of claim 36, wherein the interactive advertisement is targeted to the user.

48. The system of claim 36, wherein the first storage medium is selected from a group consisting of floppy disk, hard disk, optical disk, flash memory, DVD, CD, and video tape.

49. The system of claim 43, wherein the user identification is stored in a memory in a consumer device selected from a group consisting of set up box, television set, video cassette recorder, CD-R(W), DVD-R(W), personal video recorder, and personal computer.

50. The system of claim 36, further comprising a return communication path from the remote site for the transmitted transaction request.

51. The system of claim 36, wherein the trigger is stored in the first storage medium.

52. The system of claim 37, wherein the prompting is displayed in a full screen television mode.

53. The system of claim 37, further comprising an interactive program guide for displaying the prompting.
